(19) United States
(12) Patent Application Publication
(10) Pub. No.: US 2018/0365616 A1
(43) Pub. Date: Dec. 20, 2018

(54) SYSTEMS AND METHODS FOR MANAGEMENT OF INVENTORY AUDITS

(71) Applicant: Walmart Apollo, LLC, Bentonville, AR (US)

(72) Inventors: Robert James Taylor, Rogers, AR (US); Matthew David Alexander, Rogers, AR (US); Shawn M. Hodge, Bentonville, AR (US)

(21) Appl. No.: 16/013,511

(22) Filed: Jun. 20, 2018

Related U.S. Application Data
(60) Provisional application No. 62/522,501, filed on Jun. 20, 2017.

(51) Int. Cl. G06Q 10/06; G06Q 10/08

(52) U.S. Cl. CPC G06Q 10/06315; G06Q 10/087; G06Q 10/06316

(57) ABSTRACT

A logistics cycle system for managing inventory audits is disclosed. Users are dynamically assigned one or more audit tasks and are guided through performing the tasks and entering results into a mobile device. In embodiments, the logistics cycle system includes a rules engine comprising a set of inventory audit rules, an inventory database, an inventory audit application program interface (API) coupled with the rules engine and the inventory database, and a plurality of mobile electronic devices. The API is configured to build a plurality of different dynamic audit task lists, each including at least one non-confirmation query, based on the set of inventory audit rules and the inventory data, compare received task response data with the inventory data, and update at least one of the plurality of dynamic audit task lists to include a mismatch reconciliation task if there is a mismatch between the task response data and the inventory data.

### RELATED APPLICATION

The present application claims the benefit of U.S. Provisional Application No. 62/522,501 filed Jun. 20, 2017, which is incorporated by reference in its entirety herein.

### TECHNICAL FIELD

Embodiments of the present disclosure relate generally to the field of computer-assisted inventory management.

### BACKGROUND

Inventory management is a complex task for retailer stores and other businesses. Inventory audits are carried out periodically in order to determine that expected products, and quantities of products, are in fact received and/or available.

In some facilities or organizations, perpetual inventory processes are used to audit stock on hand. For example, a retail location or distribution facility may conduct an inventory audit daily or on each operational day to get a daily audit result. Daily audit results then can be averaged or accumulated. In other examples, audits are conducted periodically according to a schedule, on-demand when circumstances indicate an audit is necessary or could be helpful, or according to some other plan or schedule.

Many conventional auditing processes involve printing a hard copy inventory report, and sending an inspector, such as an employee, contractor, associate, or autonomous device, to each inventory location to conduct a manual visual inspection. The inspector then marks up the report with either a confirmation of the count on the report or a correction to the report, based on the inspector's visual inspection. In some audits or situations, such as in distribution centers, a presence or absence, rather than a count, of products or inventory in an area or space are checked. This can be helpful to track logistics cycling, particularly in distribution centers or other facilities in which products move in and out frequently.

The report is then provided to a manager (or other associate) for further handling and updating of the inventory or cycle information at a central location. This process can be tedious and time-consuming, and the accuracy of the results is highly dependent on the inspector performing the visual inspection. Moreover, such conventional processes lack controls over the inspector in performing the inspection, and do not include mechanisms to confirm that the results returned by the inspector were collected at the right location.

What are needed in the industry are systems and methods to assist in automating and controlling inventory management audits and inspections.

### SUMMARY

Embodiments of the present disclosure meet the industry need for systems and methods to assist in automating and controlling inventory management audits and inspections. Inspectors, such as users or autonomous devices, can be dynamically assigned one or more audit tasks and are guided through performing the tasks and entering results into a mobile device.

In embodiments, a logistics cycle system for managing inventory includes a rules engine comprising a set of inventory audit rules, an inventory database comprising inventory data, an inventory audit application program interface (API) coupled with the rules engine and the inventory database, and a plurality of mobile electronic devices, such as a smartphone, a tablet computer, or a mobile retail computer device such as an MC40 or a TC70.

The set of inventory audit rules includes a location cycle rule defining if an audit of a location will take place based on whether an inventory change is expected to have occurred at the location since a previous inventory audit, and an item type rule defining a type of audit that will take place at the location based on at least one of a product size, a product value or a product through-rate at the location.

The inventory audit API is configured to build a plurality of different dynamic audit task lists, each including at least one non-confirmation query, based on the set of inventory audit rules and the inventory data, compare received task response data with the inventory data, and update at least one of the plurality of dynamic audit task lists to include a mismatch reconciliation task if there is a mismatch between the task response data and the inventory data. In embodiments, the non-confirmatory query relates to at least one of a product quantity, a product presence or absence, or an available space for the product.

Each of the plurality of mobile devices is configured present a different one of the plurality of dynamic audit task lists in a user interface which is configured to present the dynamic audit task list as a series of discrete tasks and to receive task list response data in response to each discrete task.

In embodiments, the dynamic audit task list that is updated to include the mismatch reconciliation task is presented on a different mobile electronic device from the one that received the task response data.

In embodiments, the inventory API is configured to update the inventory data in the inventory database if a result of the mismatch reconciliation task response data matches the task response data.

In embodiments, the inventory API is configured to build the plurality of different dynamic audit task lists based at least in part on an efficient physical route to be taken between a plurality of product locations selected by the location cycle rule.

In embodiments, the set of inventory audit rules comprises a distribution center subset of inventory audit rules and a retail store subset of inventory audit rules. In embodiments, the retail store subset of inventory audit rules comprises at least one of a product pallet-level inventory audit rule or a cold chain compliance audit rule.

In embodiments the inventory API includes a reporting engine configured to aggregate the received task response data from the plurality of mobile electronic devices and analyze the aggregated data to determine at least one user-level metric. The user level metrics can be used to determine inventory audit rules.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a block diagram depicting components of a logistics cycle system, according to an embodiment.

FIG. 2 is a block diagram depicting components of an inventory API, according to an embodiment.

FIG. 3A is a block diagram depicting data elements of an audit data store, according to an embodiment.

FIG. 3B is a block diagram depicting data elements representing a task, according to an embodiment.

FIG. 3C is a block diagram depicting data elements representing a task response, according to an embodiment.

FIG. 4 is a flowchart depicting a method for guiding a user to perform one or more audit tasks, according to an embodiment.

FIG. 5A is a block diagram depicting a user interface screen, according to an embodiment.

FIG. 5B is a block diagram depicting a user interface screen, according to an embodiment.

FIG. 5C is a block diagram depicting a user interface screen, according to an embodiment.

FIG. 5D is a block diagram depicting a user interface screen, according to an embodiment.

FIG. 5E is a block diagram depicting a user interface screen, according to an embodiment.

FIG. 6 is a flowchart depicting a method for processing a task response, according to an embodiment.

FIG. 7 is a flowchart depicting a method for generating a global task list, according to an embodiment.

FIG. 8 is a flowchart depicting a method for generating a user specific task list, according to an embodiment.

FIG. 9A is a screenshot depicting a user interface screen, according to an embodiment.

FIG. 9B is a screenshot depicting a user interface screen, according to an embodiment.

FIG. 9C is a screenshot depicting a user interface screen, according to an embodiment.

FIG. 9D is a screenshot depicting a user interface screen, according to an embodiment.

FIG. 9E is a screenshot depicting a user interface screen, according to an embodiment.

FIG. 9F is a screenshot depicting a user interface screen, according to an embodiment.

FIG. 9G is a screenshot depicting a user interface screen, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

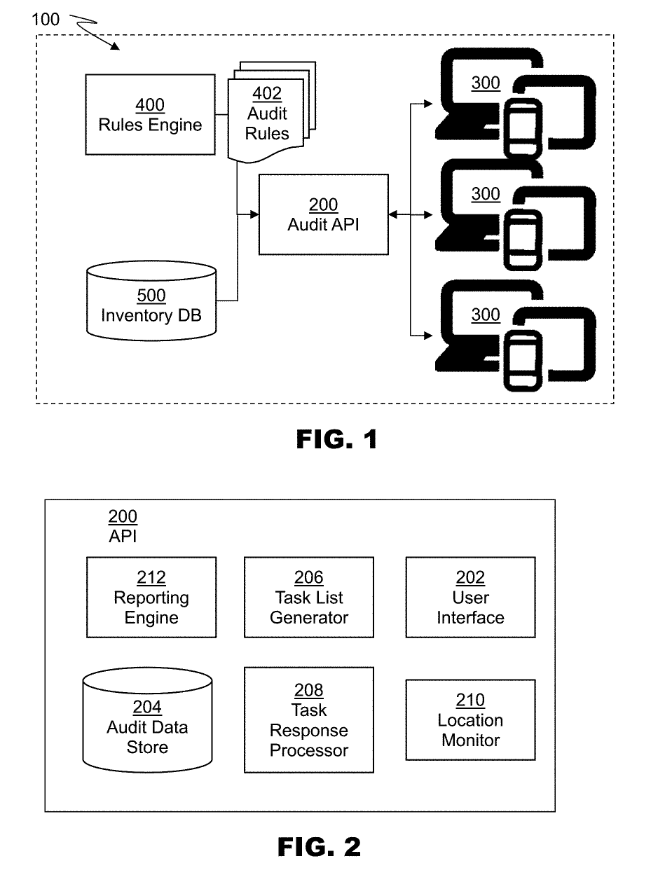

FIG. 1 is a schematic diagram depicting components and engines of a logistics cycle system 100 for managing inventory audits, according to embodiments of the present disclosure. In embodiments, logistics cycle system 100 can include an application programming interface (API) 200, one or more mobile devices 300, a rules engine 400, and an inventory database 500. Logistics cycle system 100 enables conducting, controlling, and managing inventory audits.

The various components and engines of logistic cycle system 100 can reside on, or be executed by, a single or computing device, such as a mobile electronic device 300 in embodiments. In other embodiments, each of the components and engines of logistics cycle system 100 can reside on, or be executed by, a plurality of computing devices in continuous or intermittent data communication with each other.

FIG. 2 is a schematic diagram depicting components and engines of API 200. API 200 can comprise user interface 202, audit data store 204, task list generator 206, task response processor 208, location monitor 210, and reporting engine 212. In embodiments, all or portions of API 200 can reside or be executed on each of the one or more mobile devices 300.

User interface 202 is configured to present a task prompt to a user, and to receive an input based on the task prompt. In various embodiments, user interface 202 can be a command line interface, a graphical user interface, a web browser accessible interface, an augmented reality interface, or any other interface that can be presented on mobile devices 300 and receive user input. In embodiments, user interface 202 can be executed on a mobile device 300, or generated on a computer system remote from, and in data communication with, mobile device 300. In an embodiment, user interface 202 can be a programmatic interface, such that the “user” can be a computing system, robot, or other electronic device.

The user interface 202 can be presented to the user in a variety of formats, such as an overhead view of an area to be audited, with color coding used to indicate areas the associate is to visit and audit, or a map-like interface that guides a user through a set of locations to be audited. Still other user interface embodiments can provide a list of locations (e.g., bin numbers, slot numbers, aisle numbers, section numbers, etc.) for more experienced users. In embodiments, the user can select a preferred view on his or her device. In some embodiments, user interface 202 can comprise audible prompts instead of or in addition to readable (visual) prompts. In still other embodiments, user interface 202 can provide and receive augmented reality inputs and outputs to guide the associate through tasks using visual, audible and/or haptic feedback.

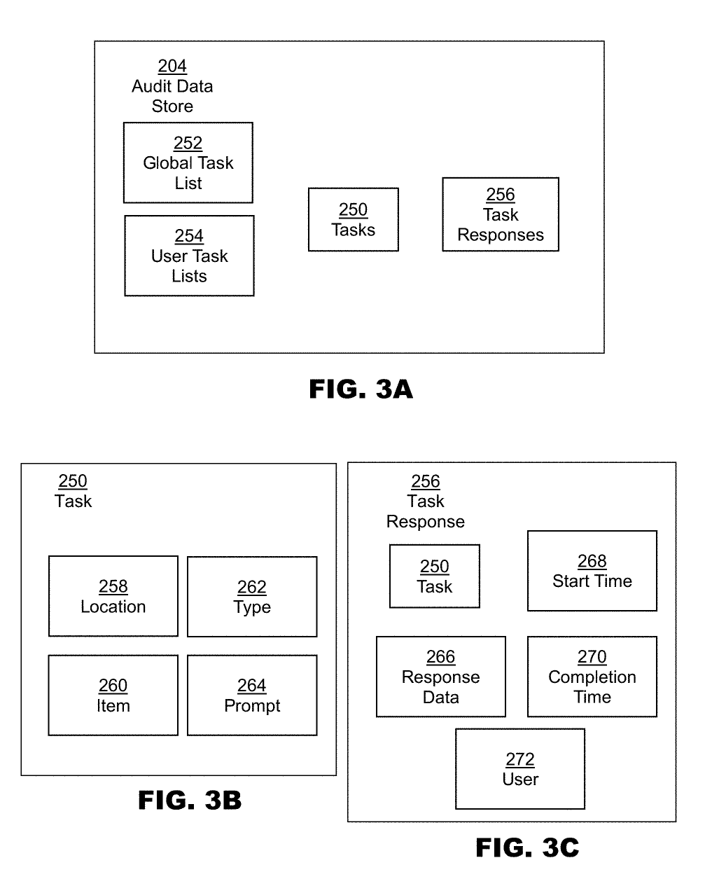

Audit data store 204 can comprise a database or other file structure stored volatile or non-volatile memory on a computing device. In embodiments, audit data store 204 can reside within or alongside inventory database 500. FIG. 3A is a block diagram depicting a data structure for audit data store 204 according to embodiments. Audit data store 204 can be configured to store audit data, which can comprise a plurality of tasks (or audits) 250, each associated with a global task list 252 and one or more user specific task lists 254. Audit data store 204 can further be configured to store a task response 256 for each task as it is completed.

FIG. 3B is a block diagram depicting a data structure for a task 250. Task 250 can comprise a location 258, an item 260, a type 262 and a prompt 264. Locations 258 can be associated with one or more inventory locations such as a slot, area, shelf, retail section, department, aisle, store site, warehouse site, distribution center, or location where an inventory task may be assigned. Each location 258 can further have an associated location type. Item 260 can be one or more items that the task 250 is associated with. In embodiments, item 260 can be a product, group of products, or a sub-location (such as a shelf, or slot).

Task type 262 can indicate the information that will be required for the task 250, such a quantity of items, an indication of whether one or more items is present, or an indication of whether one or more items has space available. Prompt 264 can indicate what the user will be requested to do, such as count one or more items, scan one or more items, determine if one or more items is present, or determine if one or more items has space available. Prompt 264 can be automatically generated based on task location 258, item 260, and type 262 in embodiments.

Task 250 can also comprise an indication of whether it is a task generated in order to reconcile a mismatch, including the task response 256 of the original task. Those of ordinary skill in the art will appreciate that tasks 250 can comprise more, fewer, or alternate data elements as needed to describe tasks to be performed by the user.

FIG. 3C is a block diagram depicting a data structure for a task response 256, according to embodiments. Task response 256 can include an identifier of the associated task 250, received response data 266, and tracking data such as start time 268, completion time 270 and user/inspector identification 272. Response data 266 can comprise one or more data elements, for example in one embodiment response data 266 can include a universal product code (UPC) identifying an item 258 and a quantity of the items found at the location. Those of ordinary skill in the art will appreciate that task responses 256 can comprise more, fewer, or alternate data elements as needed to track task responses as each task is performed.

Task list generator 206 is configured to generate global task list 252 and user tasks lists 254 based on information received from rules engine 400, inventory database 500, and stored in audit data store 204 as described in more detail below. User specific task lists 254 can each include at least one non-confirmatory query, wherein the user is not provided with an expected result, and is instead prompted only to provide the actual result. Task response processor 208 is configured to receive user input from mobile devices 300 and populate task responses 256 as appropriate, as described in more detail below.

Location monitor 210 can monitor the user's location throughout execution of a task. This monitoring can assist in ensuring that the associate is executing the task at the correct location. Location monitor 210 can determine the user's location in real time (or near-real time) by locating the user, or the mobile device 300 associated with the user. Location monitor 210 can operate via geolocation, Wi-Fi or other wireless triangulation, dead reckoning, or other locating techniques as are known in the art.

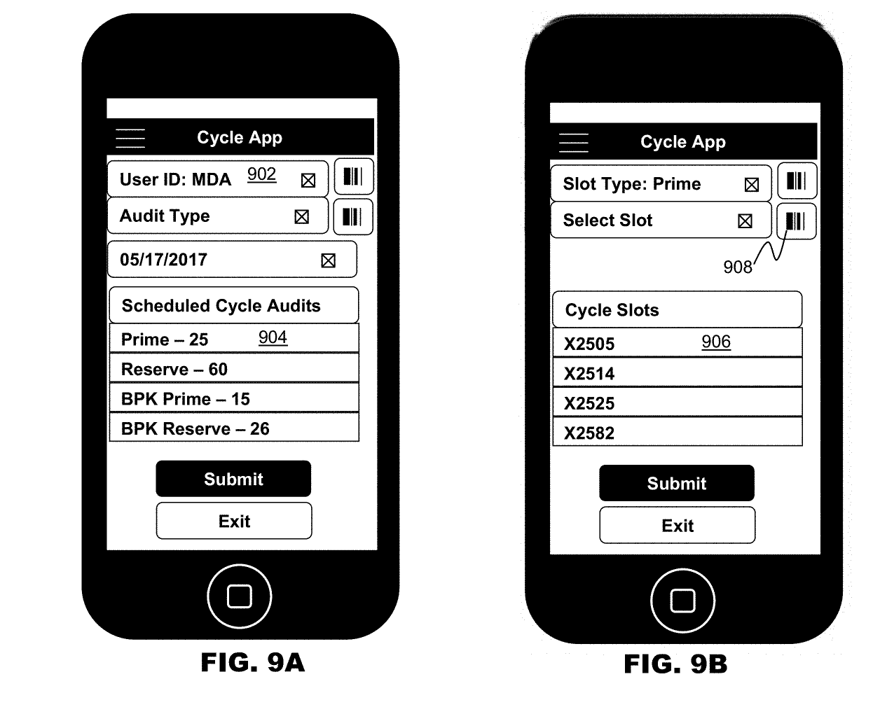

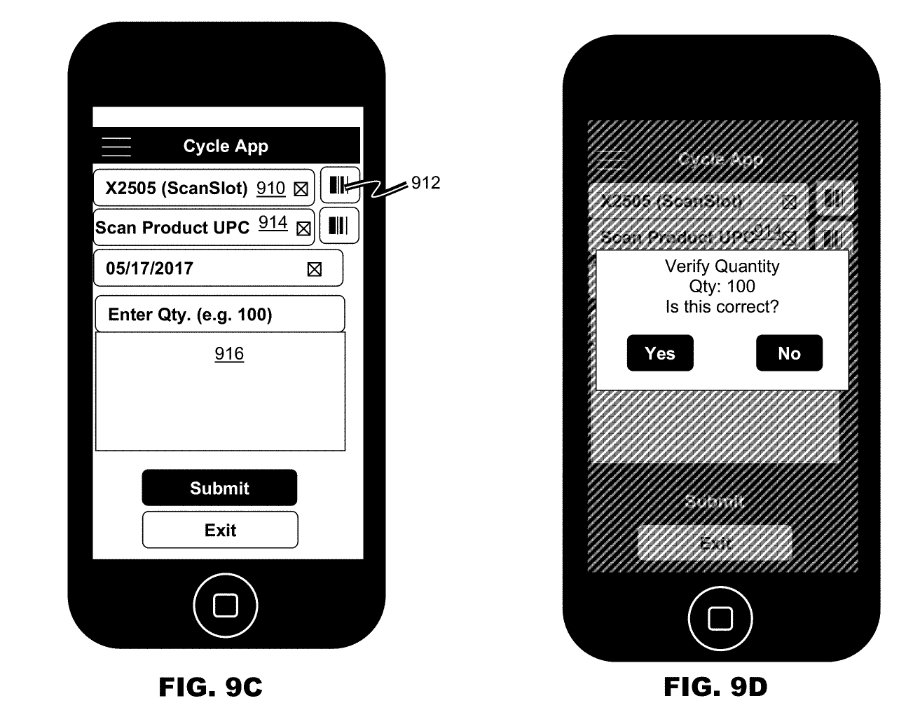

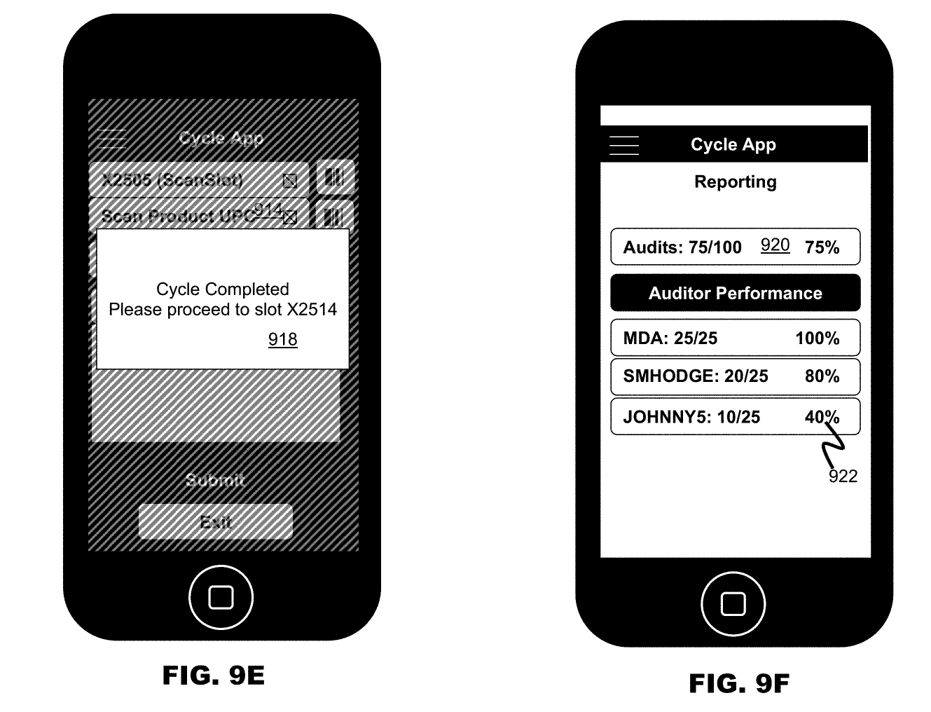

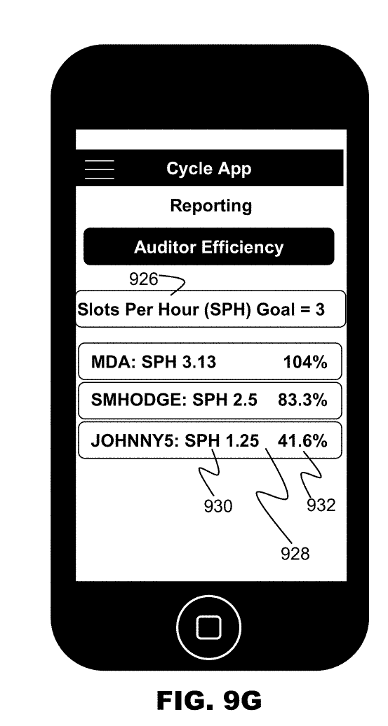

Reporting engine 212 can present audit reports based on task responses 256 and other data present in audit data store 204. Example audit reports produced by an embodiment are depicted and described in FIGS. 9F-9G and the accompanying text below. Reporting engine 212 can present a completion report, indicating the number of tasks in the global task list 252 and individual task lists 254 have been completed. Reporting engine 212 can further determine efficiency metrics which can be reported to administrators and managers and used by components of logistics cycle system 100 increase efficiency. For example, system 100 can track how long a user is at a particular location, how long it takes a user to move between locations, total audit time, and other time and/or location based metrics. From this data, the system 100 can determine how long an average user takes to carry out audit-related tasks and compare times to detect problems or inefficiencies. For example, an autonomous device may be slowed in audit-related task performance by network traffic bottlenecks. These issues can be communicated to an operations center to be addressed, or additional autonomous devices can be deployed.

In some embodiments, the API 200 can build expectations (e.g., that a certain set of tasks should take three hours, or that a certain number of locations should be completed in one hour). This expectation can be communicated to the user to provide an optimization target or used to measure the user's actual performance with respect to expected performance. API 200 can also determine and flag situations in which the associate is completing tasks significantly slower or faster than average (or faster than is possible according to the task's location or complexity).

These metrics and scores can be applicable to individual inspectors, users, teams of users, associates within a group (e.g., at a particular location), or other groupings of users. The data can enable system 100, managers, and administrators to carry out a variety of different comparisons in order to measure and improve the efficiency of audit operations. The data also can assist with planning and scheduling of inspector work, such as how many inspectors should be allocated to perform particular audit tasks on one day (or in some other time period).

In embodiments, report information and form can vary according to its purpose, timeframe, audience, or some other factor. The system can therefore produce and provide information that enables managers and administrators to check and evaluate metrics of efficiency, which currently cannot be done with conventional auditing systems.

Mobile devices 300 are configured to instruct the user to conduct the various tasks 252 generated by API 200 and to receive task responses 254 from the user. Mobile devices 300 can be any computing devices capable of presenting tasks and receiving responses in a variety of audit locations. In embodiments, each mobile device 300 can be a smartphone, a tablet computer, a network interface, or a mobile retail computer device such as an MC40 or TC70 as manufactured by Motorola.

Each mobile device 300 comprises one or more user-comprisable output interfaces (such as a screen, audio output, or haptic output), and one or more input interfaces (such as a touch screen, keyboard, mouse, or microphone). In embodiments, mobile devices 300 can comprise components for reading and or decoding tag information contained on bar codes, 2-dimensional scan codes (such as Quick Response, or “QR,” codes), computer-recognizable text, radio frequency identification (RFID) tags, or other identifying tag or mark. Such components can include barcode scanners, cameras, radio frequency identification (RFID) transponders, and the like.

Each mobile device 300 can further comprise one or more data communication interfaces enabling mobile devices 300 to communication with other components of system 100 as required. Data communication interfaces can include wired connections such as Ethernet connections, Universal Serial Bus (USB), and the like; wireless connections such as WiFi, Bluetooth, Zwave, ZigBee, I2C, and the like; and/or other communication interfaces or protocols enabling data communication between mobile devices 300 and other components of system 100.

Rules engine 400 is configured to provide audit rules 402 to API 200. Audit rules 402 can define if an audit of a location should take place and, if so, what type of audit. Location cycle rules can define whether an audit of a location should take place based on whether an inventory change is or was expected to have occurred at the location since a previous inventory audit. Item type rules can define which type of audit or audits are appropriate for a location based on aspects of the products stored at that location, such as product size, product value, or product through-rate at the location. Rules can also be defined based on user-level metrics generated by reporting engine 212. For example, if a previous audit was completed in a time that was significantly faster than the average time, a location can receive another audit sooner than normally scheduled.

Rules engine 400 can distinguish audit rules 402 by category. In embodiments, categories can be location based, such that rules engine 400 can provide a distribution center subset of audit rules 402 and a different retail store subset of audit rules 402. In embodiments, categories can be based on the packaging hierarchy, such that different audit rules 402 might apply at a product pallet-level than at an individual product level. In embodiments, categories can be based on specially handling requirements, for example, a subset of audit rules 402 might apply to cold chain compliance requirements. Each audit rule 402 can be applicable to a single category, or to multiple categories, for example, a given audit rule 402 may belong to both the distribution center subset and the retail store subset.

Inventory database 500 can be integral with or external to system 100. Inventory database 500 can provide data regarding locations 258 and the items 260 expected at each location. Depending on the situation, item, location or some other factor, inventory database 500 can comprise one or more of item information (e.g., a barcode, RFID tag, or some other identifier), item location information, item cycle information (i.e., when an item or group of items is expected to be received at a location or sent from a location), item destination information, item count, item value, or other data or information related to identifying, locating, tracking, cycling, and/or accounting for an item or group of items.

In embodiments, the various components of system 100 can be in constant or intermittent data communication with other business systems. For example, where the inspectors are employees, contractors, or other associates, task list generator 206 can receive data from a human resources system (or similar) regarding associate schedules, in order to assemble a task list that can be completed during the scheduled time while considering available associate resources.

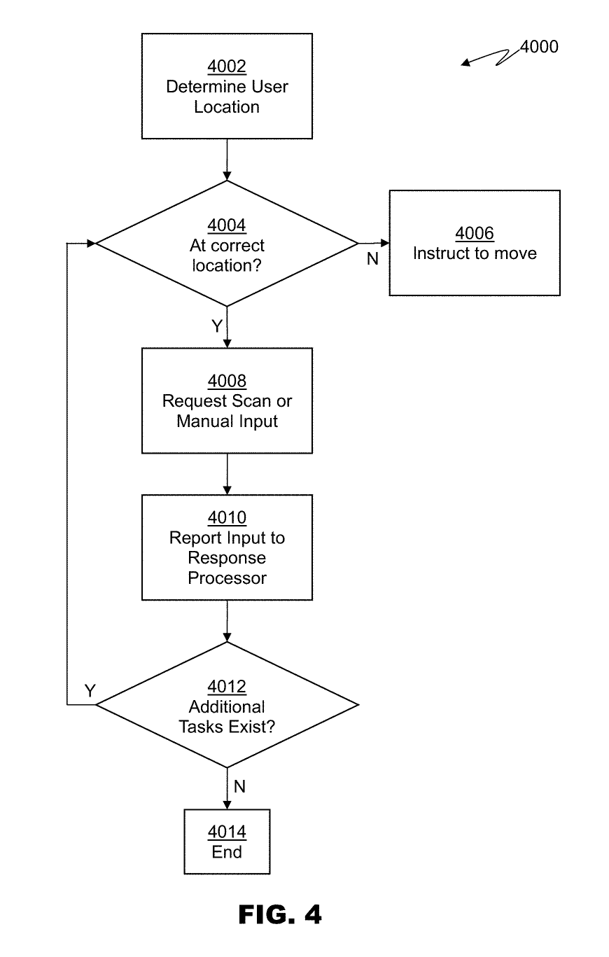

In operation, user interface 202, as presented via mobile device 300, can guide a user to perform the various steps of method 4000, depicted in FIG. 4, in order to complete the tasks of a dynamically generated task list 254.

At 4002, the location of the user can be determined by location monitor 208. In embodiments, the location can be confirmed by requesting that the user scan a location identification tag or perform some other locating task. At 4004, if the user is not in the correct location, the user is instructed to move to the appropriate location at 4006. The location can be redetermined at 4002.

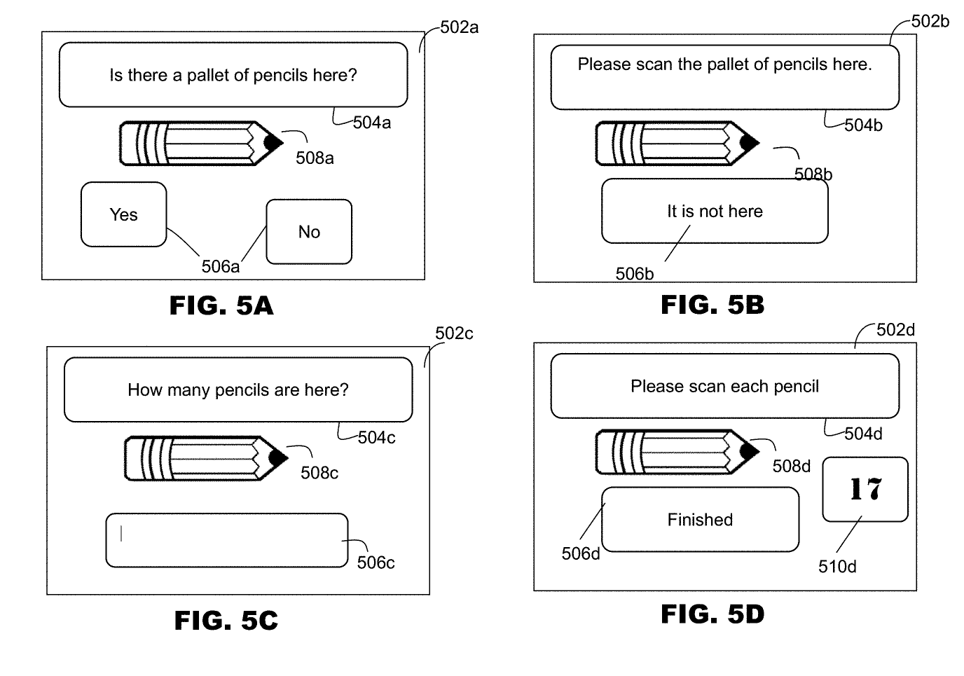

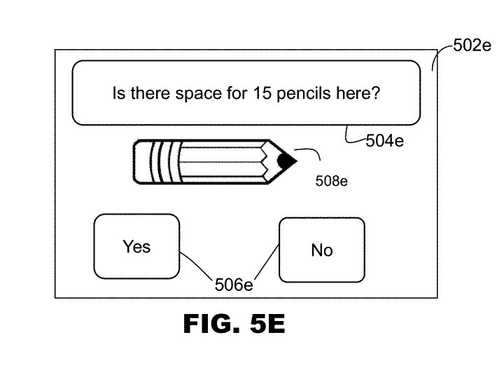

At 4008, user interface 202 can present a task 250 from a user task list 254. The requested task input can vary based on the task item 260, type 262 and prompt 264. Task input screens 502 can be dynamically generated based on tasks 250, as depicted in the various embodiments of user interface layouts provided in FIGS. 5A-5G.

FIG. 5A depicts an embodiment of a screen 502a that can be presented for manual input by a user for a presence confirmation task. Screen 502a includes a prompt 504a, and an input area 506a. In embodiments, visual 508a providing an indication to the user of what to look for may be provided. Prompt 504a can ask “Is [item] here?” Input area 506a can present “Yes” or “No” input options.

FIG. 5B depicts an embodiment of a screen 502b that may be presented for scanning input for a presence confirmation task. Prompt 504b instructs the user to “Scan the [item] here.” Input area 506b can enable the user to indicate that the item is not, in fact, present.

FIG. 5C depicts an embodiment of a screen 502c that may be presented for manual input for a batch count task. Prompt 504c asks the user “How many of [item] are here?” Input area 506c can present a text field for entry via an on screen or physical keyboard, or other mechanism for numerical input.

FIG. 5D depicts an embodiment of a screen 502d that may be presented for scanning (or auto quantity) input for a count task. Prompt 504d instructs the user to “Scan each of the [items] here.” Input area 506d can present a button for indication that the task is complete. Screen 502d can optionally also present a current count indicator 510d.

FIG. 5E depicts an embodiment of a screen 502e that may be presented for manual input for a space confirmation task. Prompt 504c asks the user, “Is there space for [# of items] here?” Input area 506e can present “Yes” or “No” input options.

Input areas 506 can include input validation, such as ensuring that numeric entry fields contain only positive integer values. Other input validation techniques known in the art can be used to inhibit data entry errors. In addition, task input screens can indicate whether the current task is a mismatch reconciliation task, including information regarding the previous user to perform the task and the previous results, where desired. In embodiments, the prompt 504 or task type 262 can be modified based on the user's accuracy rating, for example, a user with a low accuracy rating can be instructed to scan each item instead of entering a quantity.

Returning now to FIG. 4, after input is received it can be provided to task response processor 208 at 4010. At 4012, the user task list 254 can be consulted to determine if additional tasks exist, and if execution can return to 4004 where the current location can be checked before the next task is completed. In embodiments, updates to user task list 254 can be retrieved at any time (such as after performance of a task is complete), enabling more dynamic assignment of tasks to users.

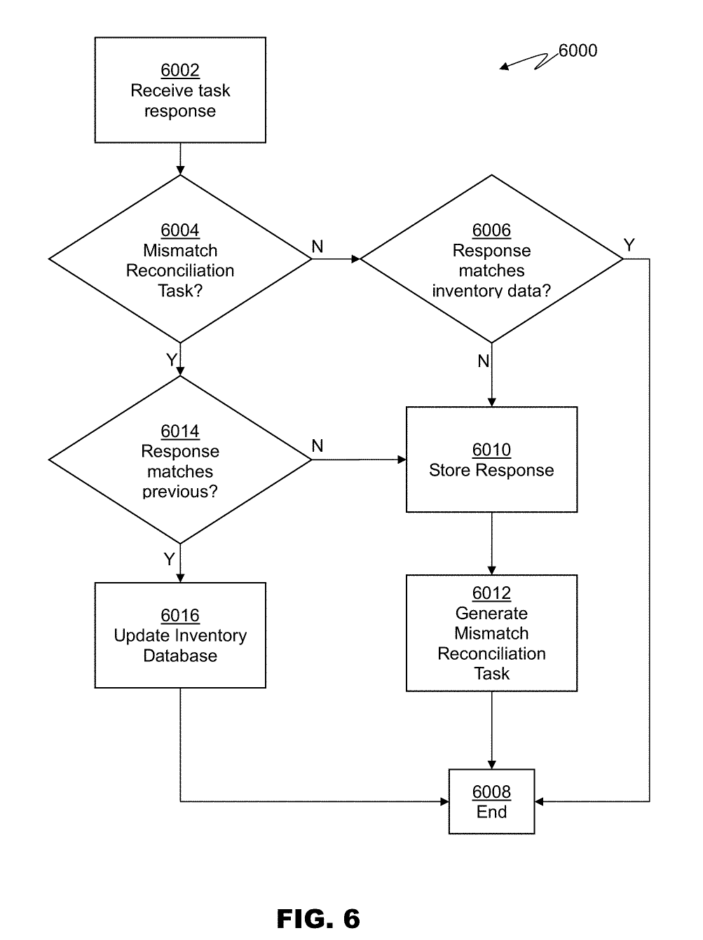

FIG. 6 is a flowchart depicting a method 6000 for processing a task response 256 upon receipt of input from. At 6002, the task response data is received (for example, as the output from 4010 of method 4000, discussed above. The task response 256 can then be evaluated based on inventory database 500, and previous task response data in audit data store 204.

If, at 6004, the task 250 is not a mismatch reconciliation task, at 6006, the task response 256 can be compared to the inventory database 500. If the task response 256 matches what is expected, processing can end at 6008. If task response 256 does not match, task response 256 can be stored at 6010 for comparison to results of a mismatch reconciliation task that is generated at 6012. In embodiments, the original task response 256 can be stored as part of the definition of the mismatch reconciliation task, while in other embodiments, the original task response 256 can be stored in a separate data store, such as inventory database 500 such that it can be retrieved based on the identification of the mismatch reconciliation task. Mismatch reconciliation task can be a repeat of the original task, or can be more or less detailed based on the applicable audit rules 402. For example, if an original task response 256 indicates that fewer full pallets of an item are present in a location than expected, the mismatch reconciliation task can involve a more thorough item-by-item count. Execution can then end at 6008.

Returning to 6004, if the task was a mismatch reconciliation task, the response can be compared to previously stored task responses at 6014. If the reconciliation task response 256 matches the previous task response, the inventory database can be updated at 6016, and execution can end at 6008. If the reconciliation task response 256 does not match the previous task response, another reconciliation task can be generated at 6010 and 6012.

In embodiments, other factors can be used to determine whether a mismatch or other reconciliation task is generated. For example, audit rules 402 can dictate that small mismatches should be ignored, or immediately updated in inventory database 500 without confirmation. User identification 272 can be used to store an accuracy rating or metric for the user. In embodiments, the history of the user performing the audit can be used to determine how likely a discrepancy between the task response 256 and the inventory database 500 is due to user error.

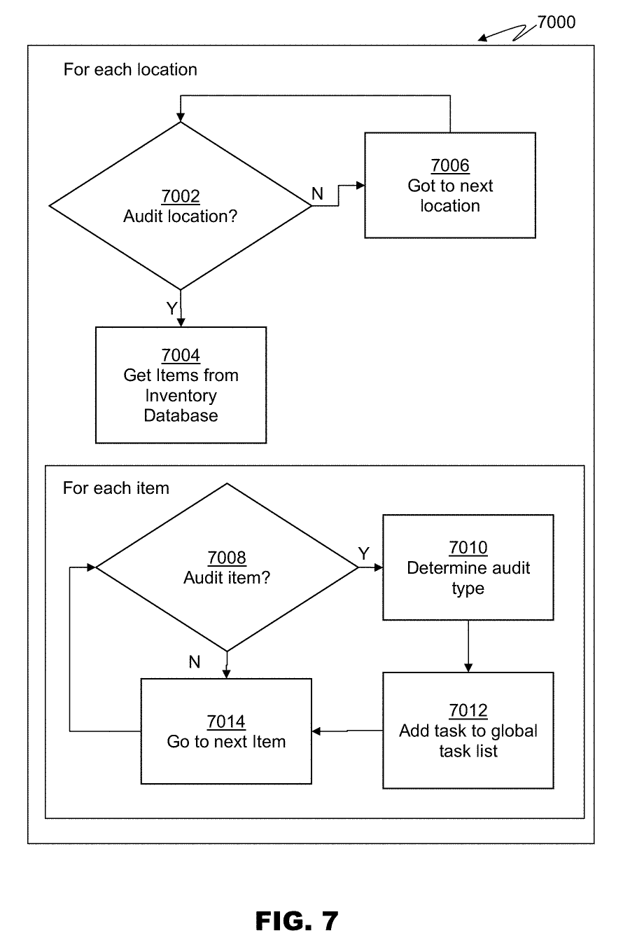

FIG. 7 is a flowchart depicting a method 7000 for generating a global task list 252, from which user task lists 254 for individual users can be created. Method 7000, as depicted, can iterate through a set of locations, and each item expected at that location. At 7002, audit rules 402 can be used to determine if the location is to be audited. At 7004, items associated with the location can be retrieved from the inventory database 500. If at 7002, the location is not to be audited, the next location can be chosen at 7006 until all locations have been processed.

In embodiments, audit rules 402 can support different inventory cycles. Reportable cycles can include a random selection of locations and items to audit in accordance with business rule. Time-based (for example, monthly or quarterly) cycles, can require a complete audit to be conducted within the applicable time period. In embodiments, report generator 210 can produce outputs depicting a percentage complete or other metric for tracking progress.

In embodiments, task list generator 206 can plan and coordinate audits, including audits conducted by multiple auditors and/or over time. For example, task list generator 206 can recognize that a particular location (such as a product area or slot) has not had any recent activity (i.e., no new inventory has come in, and no inventory has gone out) and therefore omit that slot from being audited again until there is activity in it.

Each item at the location can then be processed be processed beginning at 7008. If, based on audit rules 402, the item is to be audited, the audit type can be determined at 7010 and the task can be added to the global task list 258 at 7012. The next item can then be processed at 7014, and if no more items remain to be processed control can return to 7006. If the item is not to be audited at 7008, control can return to the 7014.

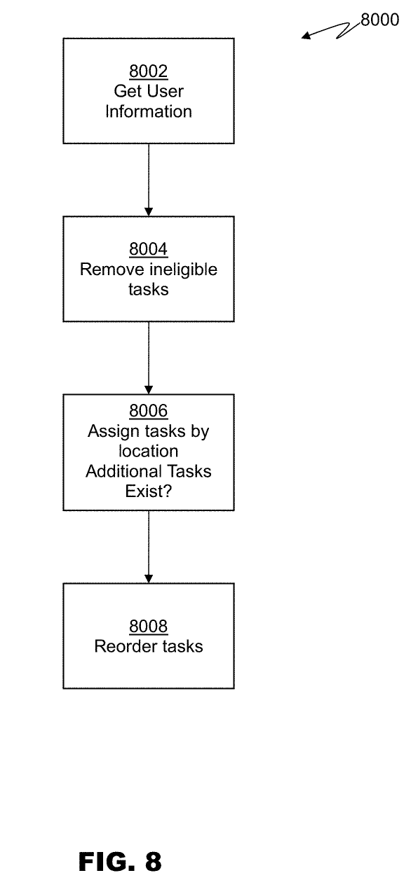

FIG. 8 is a flowchart depicting a method 8000 that can be used to assign tasks from the global task list 258 to an individual user task list 252. At 8002, user information including identity and location can be determined. At 8004, ineligible tasks can be removed from consideration.

Eligibility can be based on audit rules and/or user specific information. For example, in embodiments, ineligible tasks can include mismatch reconciliation tasks having a previous task response that was submitted by the same user, tasks occurring in locations that not reachable by the user in a feasible time period, or tasks requiring equipment that is not available to the user. In embodiments, eligibility can also be based on a user's accuracy rating, as determined based on previous task responses. For example, secondary or follow-up audits can require a user with a high accuracy rating. At 8006, tasks can then be assigned based on the user's current location, and expected location based on other assigned tasks. At 8008, tasks can be sorted in order to most efficiently route the user from task to task.

In embodiments, method 8000 can be performed a regular intervals for applicable users (for example, once per shift for all users assigned to that shift). In other embodiments, method 8000 can be reexecuted for each user as each task response 256 is received.

FIGS. 9A-9G depict a series of screenshots of an example user interface 202 of a mobile application embodiment of the present disclosure. FIG. 9A presents an initial screen, including elements enabling input of user identification 902 and selection of a task type 904 to be performed. The user identification 902 can be entered through a text input or by scanning an identification card, for example. The list of task types provided at 904 can be based on global task list 252 or user task list 254.

After submission, the screen of FIG. 9B can present a list of applicable locations (or slots) 906 and enable the user to select the starting location. The user can also select the scan function 908 to scan a barcode or other tag to indicate the starting location. This can allow a user to begin performing the tasks of the global task list 252 or user task list 254 at a location that is nearest to them.

FIG. 9C depicts a task input screen. The user can confirm the location via input box 910 or scan function 912. The user is prompted to scan the product UPC 914, and provide the quantity of the product 916. FIG. 9D presents a confirmation screen that can allow the user to correct any input errors if necessary. After input confirmation, the method 6000 (depicted in FIG. 6, with related text) can be performed as needed to store the response, update the inventory databases, and/or generate reconciliation tasks as necessary.

FIG. 9E depicts a screen indicating that the tasks assigned to the user's current location have been completed. A routing instruction 918 can direct the user to proceed to the next location. The next location can be selected to route users efficiently through a site, and can also consider whether a potential next location is occupied by a different user performing audit tasks. For example, if the closest location is occupied, the next location can be the second closest location, or the user can be routed in a different direction through the site to avoid conflicts. Because the starting location was selected by the user, the system 100 can ensure that all tasks in the list are completed, regardless of order.

FIG. 9F depicts a performance reporting screen presenting the results of a performance report that can be generated by reporting engine 212. The overall completion percentage of tasks in the global task list 252 is shown at 920. In addition, the completion percentage for each user task list 254 is shown at 924.

FIG. 9G depicts an efficiency reporting screen presenting the results of an efficiency report that can be generated by reporting engine 212. A time-based goal (e.g., slots per hour) is shown at 926. At 928, the actual slots per hour 930, and an efficiency percentage 932, are shown for each user.

Those of ordinary skill in the art will appreciate that the systems and methods of the present disclosure provide a number of beneficial features. For example, in contrast to conventional pen-and-paper audit processes that might list the inventory count that should be on hand, the user interface 202 can prompt the user for a presence/absence indication or a current count without providing this “answer” to the user beforehand. This can reduce the likelihood of a user intentionally or inadvertently entering the expected number rather than actually counting, or marking an inventor area as having or not having inventory without actually visually inspecting the area.

In addition, the systems and methods of the present disclosure can guide and prompt the user through each step in the inventory process to ensure all tasks are completed. This can reduce the burden of training users in how to properly perform inventory management processes.

The systems and methods also can design logistics cycling or inventory auditing task lists with intelligence, such that inventory areas that have not seen product turnover since the last check can be omitted while others for which there are questions, or a cycling of product in or out is anticipated to have occurred, can be prioritized.

Therefore, while conventional methods of assigning and reviewing audit tasks require manual steps by managers and/or inspectors, the systems and methods of the present disclosure provide specific technology that enables the automation of task assignment and review.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the system 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring device allows remote transmission, secondary utilization of controllers secures data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI includes a source of substantially all continuously-utilized near term data. However, KRI may be discarded depending upon the degree to which such KRI has any value based on local processing and evaluation of such KRI. In an exemplary embodiment, KRI may not even be utilized in any form if it is determined that KRI is transient and may be considered as signal noise.

Furthermore, in an exemplary embodiment, the kernel can reject generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel can filter out noisy data (“KRN”). In an exemplary embodiment, KRN, like KRI, includes substantially a continuously utilized near term source of data, but KRN may be retained in order to provide a predictive model of noisy data.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A logistics cycle system for managing inventory comprising:
a rules engine comprising a set of inventory audit rules, the set of inventory audit rules including:
a location cycle rule defining if an audit of a location will take place based on whether an inventory change is expected to have occurred at the location since a previous inventory audit, and
an item type rule defining a type of audit that will take place at the location based on at least one of a product size, a product value or a product through-rate at the location;
an inventory database comprising inventory data;
an inventory audit application program interface (API) communicatively coupled with the rules engine and the inventory database and configured to:
build a plurality of different dynamic audit task lists based on the set of inventory audit rules and the inventory data, the dynamic audit task lists comprising at least one non-confirmatory query,
compare received task response data with the inventory data, and
if there is a mismatch between the task response data and the inventory data, update at least one of the plurality of dynamic audit task lists to include a mismatch reconciliation task; and
a plurality of mobile electronic devices, each mobile electronic device configured to host an instance of the inventory audit API to present a different one of the plurality of dynamic audit task lists in a user interface, the user interface configured to present the dynamic audit task list as a series of discrete tasks and receive the task list response data in response to each discrete task.

2. The system of claim 1, wherein the non-confirmatory query relates to at least one of a product quantity, a product presence or absence, or an available space for the product.

3. The system of claim 1, wherein the dynamic audit task list updated to include the mismatch reconciliation task is presented on a different one of the plurality of mobile electronic devices from the one of the plurality of mobile electronic devices that received the task response data.

4. The system of claim 1, wherein the inventory API is configured to update the inventory data in the inventory database if a result of the mismatch reconciliation task response data matches the task response data.

5. The system of claim 1, wherein the inventory API is configured to build the plurality of different dynamic audit task lists based at least in part on an efficient physical route to be taken between a plurality of product locations selected by the location cycle rule.

6. The system of claim 1, wherein the set of inventory audit rules comprises a distribution center subset of inventory audit rules and a retail store subset of inventory audit rules.

7. The system of claim 6, wherein the retail store subset of inventory audit rules comprises at least one of a product pallet-level inventory audit rule or a cold chain compliance audit rule.

8. The system of claim 1, wherein the mobile electronic device comprises at least one of a smartphone, a tablet computer, or a mobile retail computer device.

9. The system of claim 1, wherein the inventory API comprises a reporting engine configured to aggregate the received task response data from the plurality of mobile electronic devices and analyze the aggregated data to determine at least one user-level metric.

10. The system of claim 9, wherein the set of inventory audit rules comprises at least one rule based on the at least one user-level metric.

11. A method of managing inventory auditing comprising:
defining a set of inventory audit rules including:
a location cycle rule defining if an audit of a location will take place based on whether an inventory change is expected to have occurred at the location since a previous inventory audit, and
an item type rule defining a type of audit that will take place at the location based on at least one of a product size, a product value or a product through-rate at the location;
building, by an inventory audit application program interface (API), a plurality of different dynamic audit task lists based on the set of inventory audit rules and inventory data called from an inventory database;
presenting each of the plurality of different dynamic audit task lists in a user interface of a hosted instance of the inventory audit API on a respective plurality of mobile electronic devices, wherein the presenting includes providing a series of discrete tasks of the dynamic audit task list in the user interface;
receiving task response data in each user interface in response to each discrete task;
comparing the received task response data with the inventory data; and
if there is a mismatch between the task response data and the inventory data, updating at least one of the plurality of dynamic audit task lists to include a mismatch reconciliation task.

12. The method of claim 11, wherein the non-confirmatory query relates to at least one of a product quantity, a product presence or absence, or an available space for the product.

13. The method of claim 11, further comprising presenting the dynamic audit task list updated to include the mismatch reconciliation task on a different one of the plurality of mobile electronic devices from the one of the plurality of mobile electronic devices that received the task response data.

14. The method of claim 11, further comprising updating the inventory data in the inventory database if a result of the mismatch reconciliation task response data matches the task response data.

15. The method of claim 11, wherein the building comprises building the plurality of different dynamic audit task lists based at least in part on an efficient physical route to be taken between a plurality of product locations selected by the location cycle rule.

16. The method of claim 11, wherein defining comprises defining a distribution center subset of inventory audit rules and a retail store subset of inventory audit rules.

17. The method of claim 16, wherein the retail store subset of inventory audit rules comprises at least one of a product pallet-level inventory audit rule or a cold chain compliance audit rule.

18. The method of claim 11, further comprising:
aggregating the received task response data from the plurality of mobile electronic devices; and
analyzing the aggregated data to determine at least one user-level metric.

19. The method of claim 18, wherein the set of inventory audit rules comprises at least one rule based on the least one user-level metric.
